(19) United States
(12) Patent Application Publication
(10) Pub. No.: US 2006/0095583 A1
(43) Pub. Date: May 4, 2006

(54) Uniform disk image for performing computer diagnostics

(76) Inventors: Eric Owhadi, Tomball, TX (US); Jean-Francois Larvoire, Meylan (FR); Christophe Le Rouzo, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/987,648

(22) Filed: Nov. 12, 2004

(51) Int. Cl. G06F 15/173

(52) U.S. Cl. 709/238

(57) ABSTRACT

A method of operating a computer includes re-directing access requests for a first peripheral device to a boot image residing on a second peripheral device of the computer. A reset is then performed, wherein the computer boots an operating system from the boot image.

### TECHNICAL FIELD

This invention relates to the field of computer. In particular, this invention is drawn to the diagnosis of a computer using a boot image suitable for booting from a number of peripheral devices.

### BACKGROUND

Computer systems typically include hardware components such as processors, power supplies, nonvolatile storage, peripheral devices, etc. Some of the components have firmware that can be modified by the user to tailor the component configuration for the particular system it is installed within. Application software for any number of applications may also be installed. Typically such software is installed on a magnetic or optical disk for nonvolatile storage.

Unfortunately, the computer system can malfunction as a result of either software or hardware problems. Sources of malfunction include failing components, misconfigured components, conflicts between application programs, operating system errors, etc. Exposure of the computer system to sources of malicious software (e.g., viruses, worms, etc.) may also result in malfunction. Identification and resolution of the malfunction typically involves executing a diagnostic program.

One approach is to provide the user with a compact disk (CD) containing the diagnostics and a restoration program. Due to the continuously evolving nature of software, however, the diagnostics as well as the restoration program are usually obsolesced rather quickly. Another disadvantage of this approach is that the user's nonvolatile storage (including the user's data and any application programs) is typically erased as part of the restoration process. The user is then forced to rebuild or re-install the software components to bring the computer system up-to-date with current drivers and operating system components.

Another approach is to provide diagnostics on a hidden partition (i.e., ordinarily inaccessible by the user) of the hard drive. The hidden partition is subject to intentional or unintentional erasure or loss. As with the CD approach, the diagnostics and restoration program are still likely to be obsolete by the time the user needs them.

### SUMMARY

In view of limitations of known systems and methods, various methods and apparatus for operating a computer are described. In one embodiment, a method of operating a computer includes re-directing access requests for a first peripheral device to a boot image residing on a second peripheral device of the computer. A reset is then performed, wherein the computer boots an operating system from the boot image.

### BRIEF DESCRIPTION OF THE DRAWINGS

FIG. 1 illustrates one embodiment of a method for diagnosing a computer.

FIG. 2 illustrates one embodiment of a network environment.

FIG. 3 illustrates one embodiment of a diagnostic web page.

FIG. 4 illustrates one embodiment of a computer.

FIG. 5 illustrates one embodiment of a computer boot process.

FIG. 6 illustrates one embodiment of a partitioned hard disk.

FIG. 7 illustrates one embodiment of a bootable optical disk.

FIG. 8 illustrates one embodiment of a method of diagnosing a computer.

FIG. 9 illustrates one embodiment of a hard disk partition having a boot image.

FIG. 10 illustrates one embodiment of a boot image.

FIG. 11 illustrates one embodiment of a method for booting from a boot image.

FIG. 12 illustrates one embodiment of a method of booting a boot image from a hard drive using BIOS calls.

FIG. 13 illustrates one embodiment of a method of analyzing diagnostic results.

### DETAILED DESCRIPTION

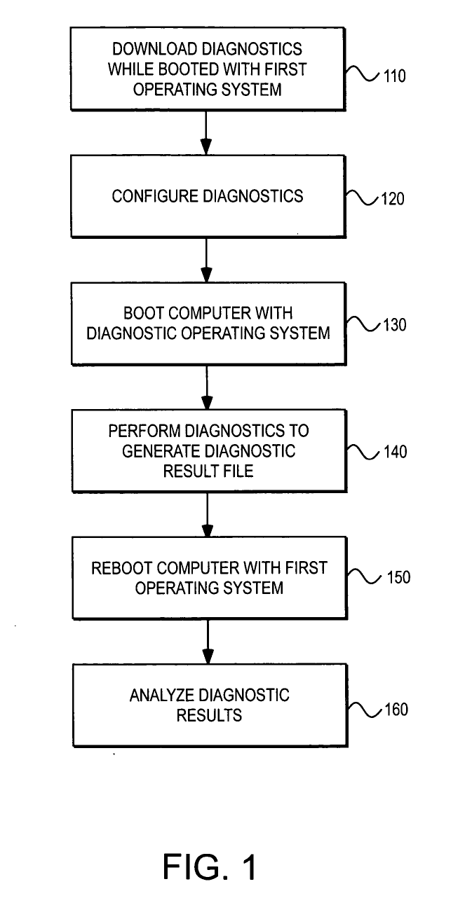

FIG. 1 illustrates one embodiment of a method for diagnosing a computer. In step 110, diagnostics are downloaded to a targeted computer while the targeted computer is booted with a first operating system (i.e., OS1). The diagnostics may include programs, databases, and other support files required to perform a diagnostic on the targeted computer. In one embodiment, the diagnostics are downloaded from a web site.

The computer is configured to support the diagnostic process in step 120. This may require modification of computer settings or various files residing on peripheral devices to enable the diagnostic process to be executed properly.

The computer is booted with the diagnostic operating system in step 130. The diagnostic operating system may also be referred to as the second operating system (i.e., OS2). Although the first and second operating systems may be based on the same operating system kernel architecture, typically the diagnostic operating system has a reduced functionality from that of the first operating system due to the limited purpose of the diagnostic operating system.

The diagnostics are performed in step 140 to generate a diagnostic result file. The result file may contain information regarding the computer environment including make, model/version, capacity or other specification of various hardware and software components including the processor, memory, device drivers, as well as the result of various tests performed by the diagnostics.

The computer is then rebooted with the first operating system (OS1) in step 150. The diagnostics are analyzed in step 160. In one embodiment, the diagnostic result file may be provided to a web site for analysis.

The process of FIG. 1 assumes that the computer is capable of being booted with the first operating system and that at least some network capability and storage capability is functional. Although the diagnostics may include tools to repair or properly configure the computer system state, preferably the diagnostics may be removed without risk of further lasting impact on the computer. This is particularly important so that the targeted computer can be returned to the state that existed prior to attempting to initiate the diagnostic process, particularly given that the user may be geographically distant for a web-based diagnostic process.

Some preliminary discussion of networks, computer architecture, boot processes, and hard drive and optical drive record layouts is required to discuss a method for diagnosing a computer incorporating web-based access and boot images.

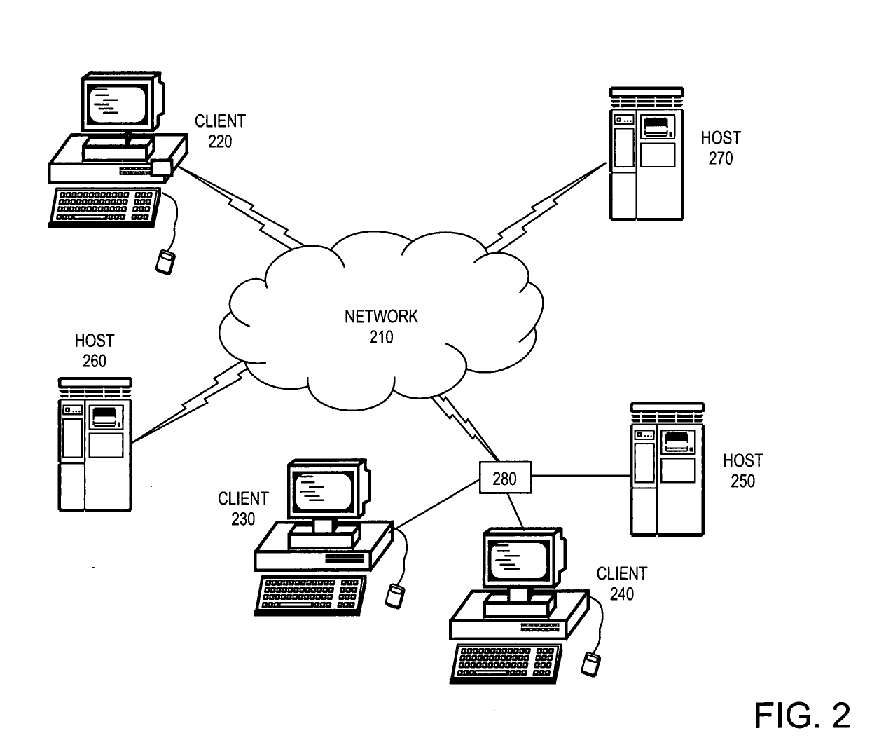

FIG. 2 illustrates a network environment including a communication network 210. Although the network may be an “intranet” designed primarily for access between computers within a private network, in one embodiment network 210 is the network commonly referred to as the Internet. The Internet includes a combination of routers, repeaters, gateways, bridges, and communications links with computers spread throughout the world. The Internet facilitates communication between computers or other devices connected to the Internet.

Some of the computers are referred to as host computers because they provide services upon request. The computers issuing the requests are referred to as client computers. The network environment of FIG. 2 includes multiple (N) client computers (220, 230, 240) and multiple (M) host computers (250, 260, 270). In some cases, a plurality of computers (e.g., 230, 240, 250) may reside on a common network that shares a common connection (e.g., via router 280) to the Internet.

The host computers (e.g., 250) and client computers (e.g., 220) can be entirely different architectures, however, to facilitate communication on network 210 they communicate by using a common communication protocol. In one embodiment, this protocol is the Transmission Control Protocol/Internet Protocol (TCP/IP).

The client computers can request services from a host computer. Hosts typically support file retrieval services, search services, communication services, and recreational services. For example, Gopher provides information retrieval services. Popular search services include Archie. Veronica is the name of another search service typically used in conjunction with Wide Area Information Servers (WAIS). Communication services include electronic mail, UseNet, Telnet, and Internet Relay Chat (IRC). An example of a recreational service is a Multi-User Dungeon (MUD).

A subset of Internet host computers provide multimedia information services. This subset of host computers permit physical access to the abstract body of information referred to as the World Wide Web (WWW) and are referred to as WWW hosts or WWW servers.

World Wide Web host computers support a protocol that permits users having computers with different architectures, operating systems, and application programs to share multimedia enhanced documents. In one embodiment, this protocol is the Hypertext Transport Protocol (“HTTP”). The multimedia enhanced documents are often referred to as “web pages.” The application specific to a given hardware platform that permits viewing the web pages is often referred to as a browser.

Hypermedia enhanced documents typically provide links (i.e., hyperlinks) to other resources in response to selection of an anchor. The anchor is typically a word, group of words, image, or some demarcated area of the document. For graphical-based browsers, the anchor is generally activated by pointing to the anchor and clicking a selection button of a pointing device such as a mouse. For text-based browsers, the anchor is generally activated by using cursor-control keys to select the anchor and pressing another key (e.g., <ENTER>). These anchors and links are defined using a language such as hypertext markup language (“HTML”). The browser interprets an HTML file to display the web page. The HTML file also determines what resource is accessed in response to activation of a given anchor.

Uniform Resource Locators (URLs) provide a standard way of referencing Internet resources including web resources regardless of whether the resource is a document, an image, a movie, a sound, or another web page. A browser, for example, can access a host machine identified by the URL and then retrieve the resource specified by the URL. A uniform resource locator (URL) is a description of an item including the location of the item that is to be retrieved. For example, the location might be the local disk drive or another file at another Internet site. The URL is not limited to other World Wide Web sites and may in fact refer to other Internet protocols and services such as Gopher, WAIS, UseNet news, Telnet, or anonymous FTP (file transfer protocol).

A URL identifies the protocol as well as the location of the item to be retrieved. For example, consider the following URL:

http://www.hp.com/diagnose/index.html

This URL identifies the protocol as “http” (“Hypertext Transport Protocol”). Other protocols include “gopher” (to initiate a Gopher session), “ftp” (to initiate a file transfer), “file” (to retrieve a local file), “wais” (for accessing a WAIS server), “news” (for reading UseNet newsgroups), and “telnet” for initiating a Telnet session.

The portion “www.hp.com” is an Internet host address or symbolic representation of an Internet host address. Thus “www.hp.com” identifies a specific host. The portion of the URL identifying the specific host is often referred to as a web site.

The remainder is a UNIX®-style path for the resource that is being accessed. Thus “diagnose/index.html” instructs a browser to retrieve the file index.html from the directory “diagnose” on the Internet host. In the event a full pathname is not provided, the host typically provides a default path. Thus the URL either explicitly or implicitly identifies a specific resource, protocol, and host machine on the Internet

A given web page may be formed from a number of resources identified within the web page's html file. For example, “index.html” contains instructions for generating a hypermedia document for the client. The client's browser interprets the html file in order to produce the corresponding web page. The html file may instruct the client's browser to access any number of other web resources located on the host or elsewhere including bitmap files, files for producing animated video or sound, etc. Each of these resources is identified either explicitly or implicitly by a URL.

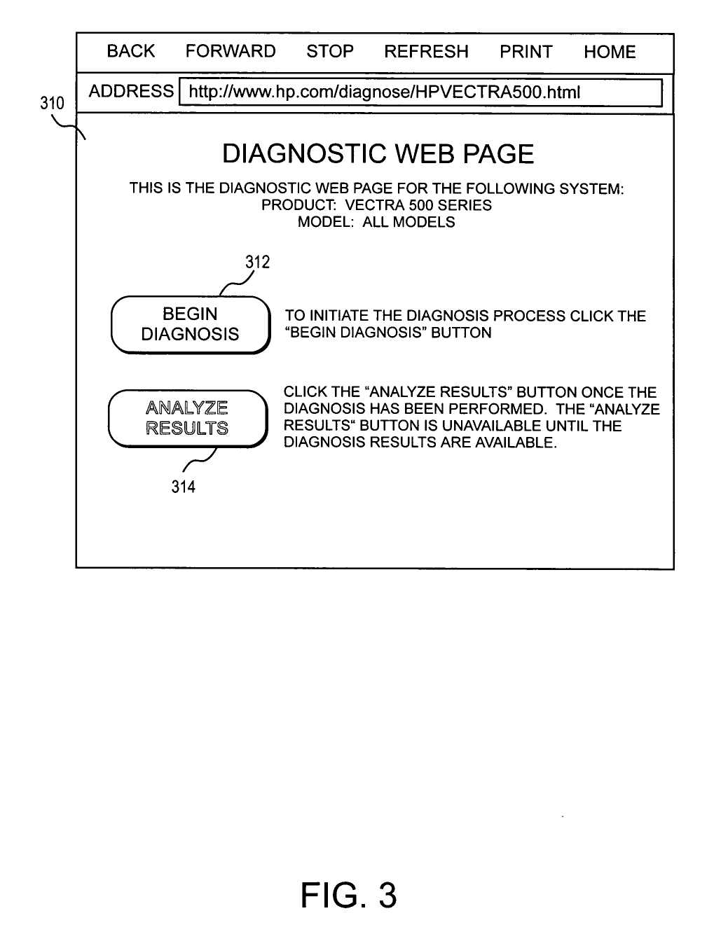

FIG. 3 illustrates one embodiment of a web page associated with diagnosing a computer. Web page 310 includes anchors 312 and 314 for accessing other web resources. Anchors are often identified by highlighted text, an icon, or an image on the web page. The highlighted text, icon, or image is associated with a URL. This association is the hyperlink. Often the terms “hyperlink” or “link” are used synonymously with the term “anchor.” Thus “anchor 312” is equivalent to “link 312,” or “hyperlink 312.” In one embodiment, the web page is defined using hypertext markup language (“HTML”) to describe the text, icons, images, etc. of the web page. Selecting an anchor effectively selects and follows the hyperlink to the resource identified by the associated URL. Selecting anchors 312 or 314, for example, will access other Internet resources that may be physically located in various host computers throughout the Internet. The selection is typically accomplished with a pointing device such as a mouse. In this case selecting hyperlink 312 (i.e., web page button 312) initiates the client computer diagnosis process.

Preferably diagnosis should occur in a “trusted” environment. This requires the computer to be booted with a trusted operating system rather than trying to perform the diagnostics within an operating system or environment that may have been compromised as a result of unknown elements.

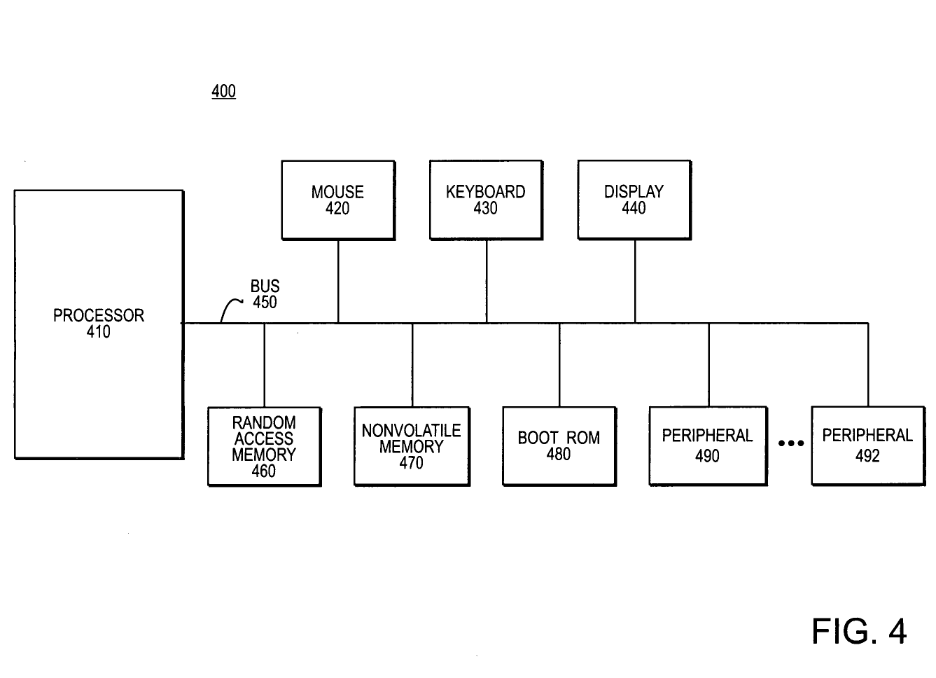

FIG. 4 illustrates one embodiment of a computer architecture. Computer 400 includes processor 410. Input devices such as mouse 420 and keyboard 430 permit the user to input data to client computer 400. Information generated by the processor is provided to an output device such as display 440. Computer 400 includes random access memory (RAM) 460 used by the processor during program execution.

RAM 460 is typically a volatile memory and does not retain its contents once power is removed from the computer system. Computer 400 includes nonvolatile memory 470 for storing configuration information even when the computer is powered down. Often parameter information that identifies specific features of the input/output devices is stored in nonvolatile memory 470. For example, parameter information might describe the number of disk drives, disk drive type, number of heads, tracks, amount of system RAM, etc. as well as the sequence in which peripherals are accessed when attempting to boot the computer (peripheral boot sequence). Various types of nonvolatile media such as electrically erasable programmable read only memory (EEPROM), flash memory, battery-backed complementary metal oxide semiconductor (CMOS) are available.

The computer additionally has one or more peripherals 490 such as a floppy drive, a hard drive, or an optical drive that supports nonvolatile storage. Compact disks (CDs) and Digital Video Disks (DVDs) are examples of media used with optical drives.

Mouse 420, keyboard 430, display 440, RAM 460, nonvolatile memory 470, and boot ROM 480 are communicatively coupled to processor 410 through one or more buses such as bus 450.

Initialization of the computer system is performed upon power-up of the computer system or hardware or software reset operations. In one approach, the processor is designed to read a pre-determined memory location when the processor is reset or powered up. The pre-determined memory location stores a pointer or an address that directs the processor to the beginning of the bootstrap routines. The pointer or address is referred to as a boot vector. For some types of resets (e.g., a “hard” or “cold” reset), the boot vector is always set to a value determined at the time of manufacture of the processor. Other types of resets (e.g., “soft” or “warm” reset) permit an alternative boot vector to be used.

For hard resets, the boot vector typically points to an address in the boot read-only memory (ROM) 480. For soft resets, however, the boot vector may point to a RAM location. The boot ROM stores the bootstrap loader and typically stores other initialization routines such as power on system test (POST). Although referred to as a ROM, the boot ROM is typically embodied at least partially as a re-writable, nonvolatile memory to permit updates.

The boot ROM may include routines for communicating with input/output devices in the computer system. In some computer systems these routines are collectively referred to as the Basic Input Output System (BIOS). The BIOS provides a common interface so that software executing on the processor can communicate with input/output devices such as the keyboard, mouse, nonvolatile mass memory storage device, and other peripheral devices.

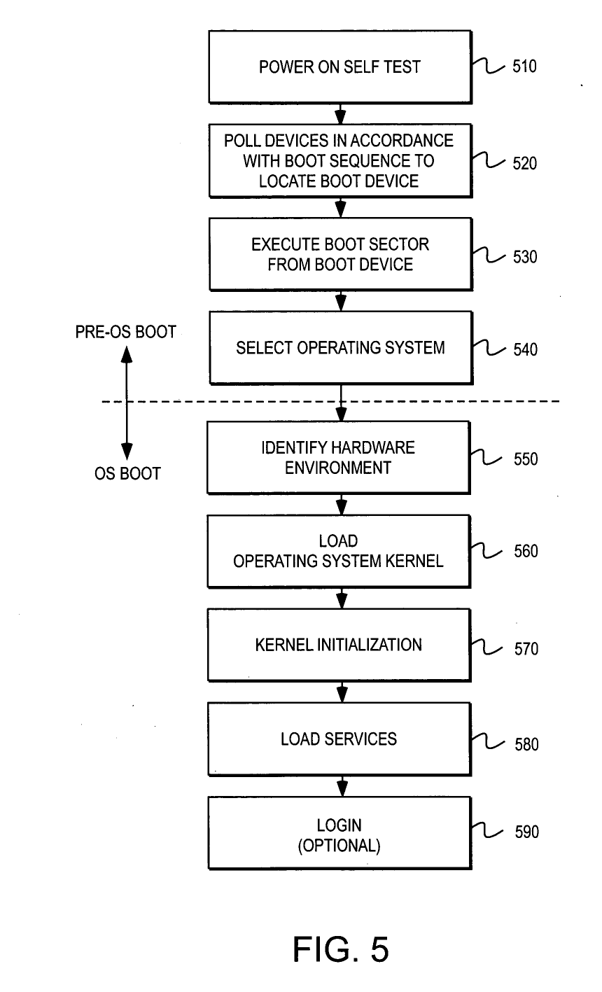

The BIOS typically permits the user to boot an operating system from any one of the floppy drive, hard drive, or optical drive. The computer follows the peripheral boot sequence in an attempt to boot from the peripheral devices. Proceeding in boot sequence order, the computer attempts to boot from the first device in the boot sequence that is bootable. One embodiment of a boot process is illustrated in FIG. 5.

Upon initialization, the processor starts executing the BIOS code stored in the boot ROM. The BIOS includes instructions for performing a Power On Self Test as indicated in step 510. The BIOS follows a peripheral boot sequence to locate a boot device in step 520. The BIOS transfers control to code located within the boot sector of the boot device as indicated in step 530. The boot sector code is operating system- and file system-specific. The BIOS, however, is still used to access the boot device.

In some architectures, the user will have the option to select from more than one operating system. Thus in step 540, an operating system to be loaded is selected. Typically, a default operating system is defined and will automatically load unless the user acts within a pre-determined time period. Steps 510-540 are referred to as a “pre-OS boot” phase.

In step 550, a hardware environment is detected. Information regarding the computer architecture is collected. The operating system kernel is loaded in step 560. In step 570, the kernel is initialized using the information gathered in step 550. Different peripherals, for example, may require distinct drivers to communicate with the operating system. The information gathered in step 550 aids in the determination of the appropriate drivers to be used by the kernel. In step 580, various services utilized by the operating system (e.g., user authorization) may be loaded. The computer then optionally provides a login authorization in step 590 before permitting access by users. Typically, the operating system is considered to have successfully booted once the user is able to successfully perform a login.

Steps 550-590 are referred to as the operating system boot phase of the boot process. Steps 550-590 are intended to represent a generic operating system boot process. The process may vary depending upon the specifics of the operating system being loaded.

The boot process was initially architected for floppy or hard disk drives as boot devices. For floppy drives, the first sector is the boot sector. Extra steps are required for locating the boot sector of a hard drive.

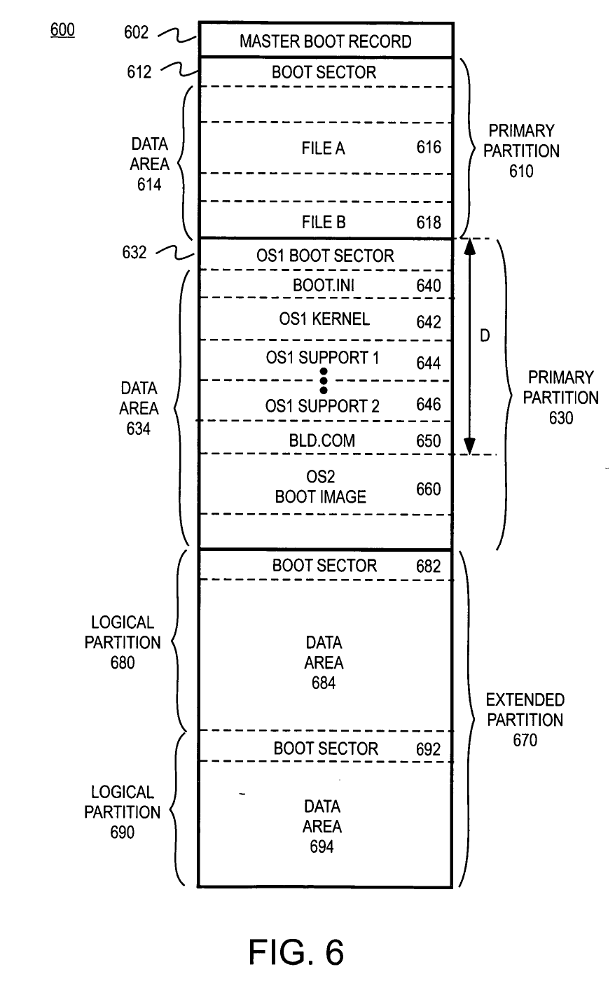

FIG. 6 illustrates one embodiment of a hard drive layout. A hard drive is typically partitioned into one or more contiguous areas 610, 630, 670. Partitions do not overlap each other. A master boot record (MBR 610) resides within the first sector of a partitioned hard drive. The MBR includes MBR code and a partition table defining the locations of various partitions of the hard drive. The code within the MBR is also referred to as the master bootstrap loader. In one embodiment, the hard drive may be partitioned into one or more primary partitions 610, 630. Alternatively, the hard drive may be partitioned into one or more primary partitions 610, 630 and a single extended partition 670.

Each partition includes a data area 614, 634, 684, 694. Extended partitions may be further subdivided into logical partitions 680, 690. Although the location and size of the extended and primary partitions are determined from the MBR partition table, the size of each logical partition 690 is determined by a partition table within the boot sector 692 of that logical partition. The location of each logical partition is determined by the location of the extended partition 670 and the size of any preceding logical partitions 680 within the extended partition as defined by the partition table in their respective boot sectors 682.

One or more files may be stored within the data area of each partition. The file system utilized may vary from partition to partition. The manner of storing and accessing the files is determined by the file system used by that partition. File A 616 and File B 618 may be stored within primary partition 610, for example. A file is the information contained by one or more logically related sectors of the hard drive. The sectors are not necessarily contiguous or sequential, but they do reside within the same partition. If the sectors of a selected file are non-sequential, the file is termed “fragmented”.

From the partition table, the MBR code locates an active partition 630 and transfers control to the code within the boot sector 632 of the active partition 630. This active partition is the partition from which the computer will attempt to load the operating system. Typically the first sector of the active partition is the partition boot sector. The code within the active partition boot sector is also referred to as the operating system bootstrap loader. Typically the bootstrap loads yet another loader for the operating system.

The code in the active partition boot sector directs the computer to execute a loader program for loading the operating system. The boot sector code is specific to the file system used by the active partition because it must be able to locate files within the partition. The loader program may be designed to load a specific operating system (e.g., OS1) or the loader program may permit a selection from a variety of operating systems (“multi-boot”). In the illustrated embodiment, the loader is one of the OS1 support files 644-646 that loads the OS1 kernel 642.

Although likewise arranged in sectors, optical disks use a different format for storing media. Nonetheless, major BIOS vendors provide a BIOS that supports bootable optical drives in accordance with a specification known as the Bootable CD-ROM Format Specification, version 1.0 (Phoenix Technologies & IBM, Jan. 25, 1995) (also referred to as the “El Torito” Specification).

The El Torito specification provides for booting from a CD that contains an image of a bootable floppy disk. A disk image is a file that contains a byte-for-byte copy of the data as it would be stored on a disk drive. Successive sectors of information from the disk drive are stored contiguously within the disk image and the sector order is preserved. An image of a bootable disk is referred to as a boot image. The disk image itself should not be fragmented by the peripheral or media it is stored on.

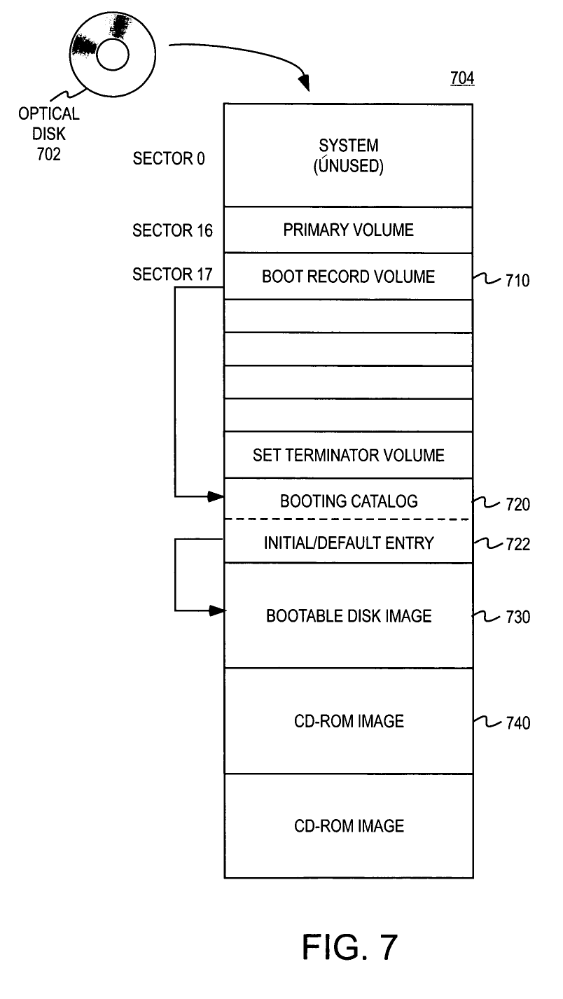

FIG. 7 illustrates one embodiment of the layout 704 of a bootable optical disk 702. The boot record volume 710 identifies the CD as a bootable CD and points to the location of the booting catalog 720. The booting catalog contains one or more entries associated with boot images. At least one entry 722 is a default entry that points to a boot image 730 to be selected in the absence of any user specifications. In one embodiment, the boot image is a floppy drive boot image. In an alternative embodiment, the boot image is a hard drive boot image. The remainder of the CD may contain other file images 740 accessible by the file system particular to the optical drive.

Various sources of computer malfunction may originate from the hardware components, software components, or both. A hardware component may fail or be misconfigured. A software component may have execution errors or conflicts with other software or hardware components. A software component may be dated, corrupted, or missing. Drivers for a particular hardware component, for example, may be missing.

Although some diagnostics may be performed by application programs executing within the user's operating system environment, better diagnostic information can be obtained by performing the diagnostics within an operating system environment that is known not to be corrupted. Diagnostic tools typically include a reduced operating system designed to facilitate diagnosis of hardware and software problems.

Diagnosis typically involves booting into a “trusted” environment with a reduced or different operating system and toolset. Various approaches include storing the diagnostic tools on removable media (e.g., floppy or optical disk) or on hidden partitions of the hard drive. All of these approaches suffer from rapid obsolescence of the tools because of the continuously changing environment of modified peripherals or updated drivers, application programs, and operating systems. Removable media such as floppy disks and optical disks is subject to physical loss. Hidden partitions are subject to unwanted modification through re-partitioning or deletion or modification of the contents. In addition the hidden partition solution requires a portion of the hard drive to be set aside (static allocation of disk space dedicated to hidden partition).

The computer system manufacturer is perhaps in the best position to provide a diagnostic solution with the most up-to-date features required to support its products on an ongoing basis. The advent of the Internet has provided a convenient mechanism for distributing the up-to-date solution to the user. In the event that the computer system is malfunctioning, however, the user may still need to rely on the alternative bootable media approach such as the bootable CD.

In order to boot from a peripheral device, the BIOS must support access of such a device because the operating system is not yet present. The “El Torito” CD boot specification supported by numerous BIOS vendors requires an operating system boot image to be stored as an image (“virtual disk”) of a hard disk or floppy disk on the CD. Removable boot media such as a bootable CD are frequently provided with the computer system at the time of purchase in order to aid the consumer in either completely initializing the system (i.e., loss of data, etc.) to a “factory new” state or in diagnosing the system so that the consumer can provide diagnostic information to support staff when the computer system malfunctions. Unfortunately, these optical disks are frequently misplaced or obsolete by the time diagnostic services need to be performed.

In the event that the computer to be diagnosed is capable of networking, a web-accessible diagnostic program may permit ready access to more recent diagnostics and drivers. In addition, the results of the diagnosis may be presented to off-site personnel for analysis.

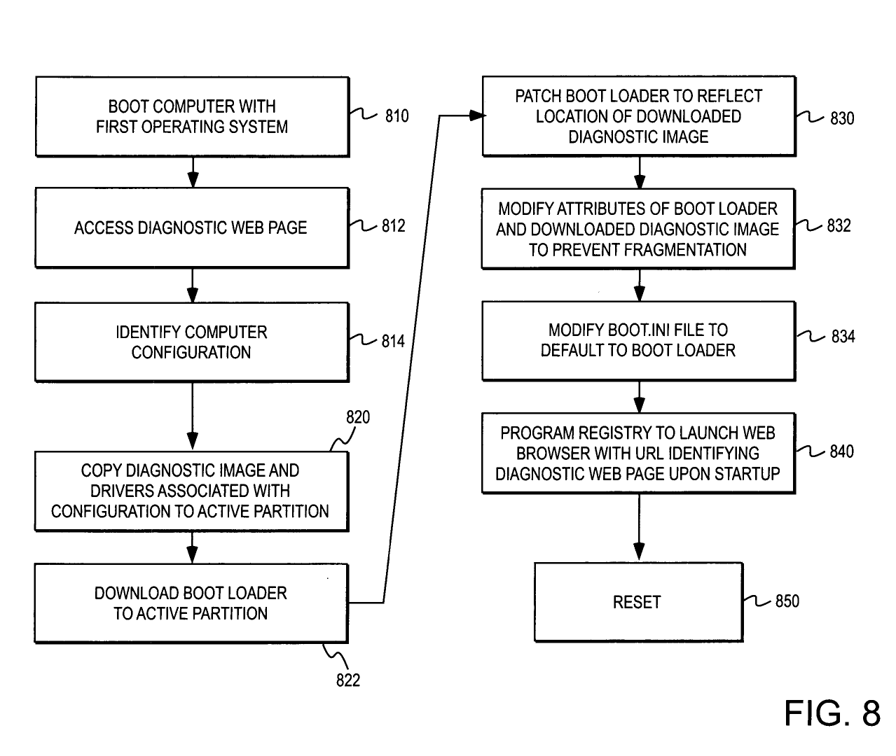

FIG. 8 illustrates one embodiment of a method of diagnosing a computer. The appropriate files including a boot image are downloaded from a web site. The boot image may be the same as that used for the optical drive.

In step 810, the computer is booted with a first operating system. A diagnostic web page is accessed in step 812. Referring to FIG. 3, for example, the user would select web page button 312 to indicate that the diagnostic process should begin.

The diagnostic process identifies the computer configuration in step 814. The computer configuration may be readily available from a configuration file residing on one of the computer's peripheral devices. Thus in one embodiment, the computer configuration is identified in step 814 by permitting the host computer to read the client computer configuration file. Alternatively, step 814 may include authorizing the download and execution of a configuration program designed to determine and report the client computer configuration to a host computer.

A diagnostic boot image and drivers specific to the computer configuration are downloaded to an active partition of a hard drive in step 820. The boot image is downloaded to sequential sectors of the hard drive so that the boot image file remains contiguous (i.e., not fragmented). Typically a bootable optical disk must be distributed with a large number of drivers to accommodate the various peripherals available for configuring a computer configuration. Step 814 enables identifying only the drivers particular to the computer configuration at hand thus avoiding the potentially bandwidth-consuming step of downloading all the drivers provided with the CD distribution.

An operating system boot loader is downloaded to the active partition in step 822. The boot loader will be referred to as a file having the name “bld.com”. In step 830, the boot loader is patched to indicate the physical location of the boot image that was previously downloaded in step 820. The boot loader and boot image file attributes are set to prevent fragmentation of the boot loader and boot image files in step 832.

Microsoft® Windows®-type operating systems provide a modifiable file “boot.ini” to permit the user to select a particular instance of the Microsoft® Windows® operating system to boot. (Microsoft Corporation located in Redmond, Wash. is the manufacturer of Windows® brand operating systems.) Different instances, for example, may load different drivers or may otherwise be tailored for specific applications. In this case, “boot.ini” is modified to append a reference to the boot loader “bld.com” for the diagnostic boot image and to identify “bld.com” as the default.

When the environment supports multiple operating systems, typically the one designated as the default will be loaded unless the user acts within some pre-determined time frame or otherwise executes an option to prevent the default from being loaded. In one embodiment, the boot loader for the diagnostic operating system is designated as the default in step 834 so that it will automatically be selected unless the user intervenes. In an alternative embodiment, the diagnostic operating system boot loader is not the default—thus the user will need to intervene to select the diagnostic operating system during the boot process.

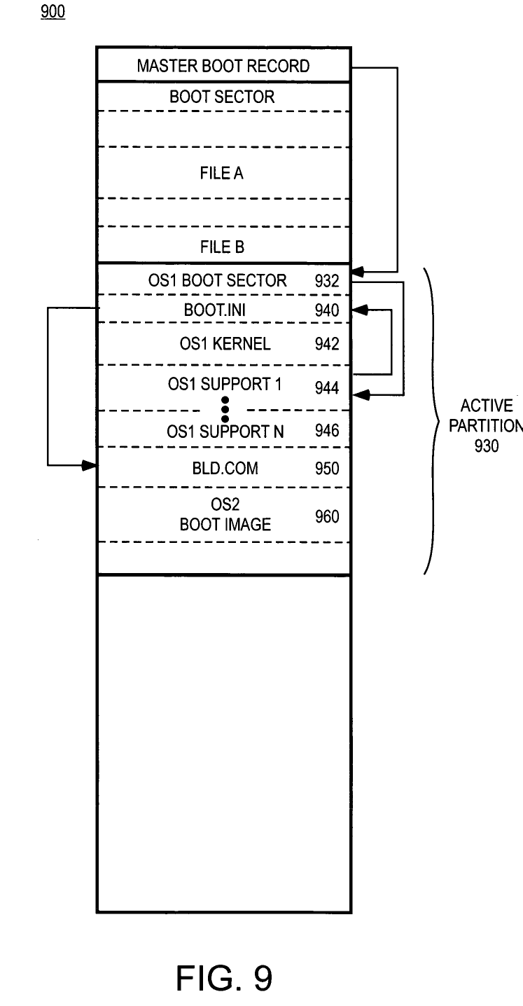

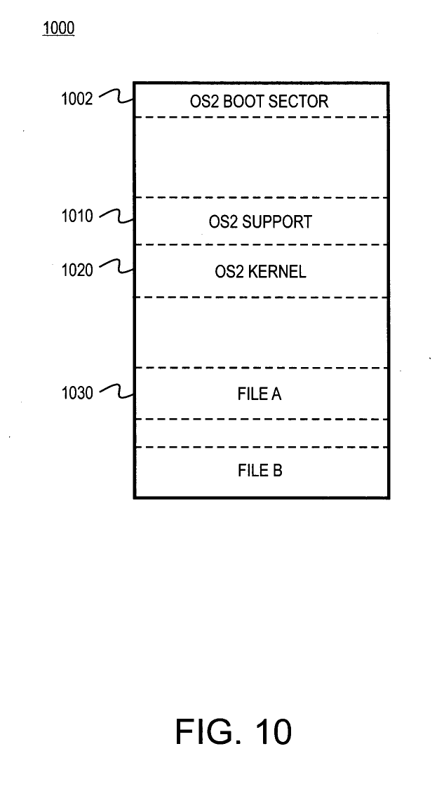

FIG. 9 illustrates one embodiment of a hard disk partition having a boot image. The first operating system files 940, 942-946 are largely left untouched with the exception of the modification of the “boot.ini” file. The modified “boot.ini” file 940, diagnostic boot image 960, and diagnostic boot loader (“bld.com”) 950 now reside within the active partition 930. One embodiment of the boot image is illustrated in FIG. 10.

The boot image 1000 is similar to another partition on the hard drive with the exception that the boot image is a contiguous file. In particular, the boot image includes an operating system kernel (OS2 kernel 1020), the operating system support files 1010, and any other files 1030 deemed appropriate. The boot image includes a boot sector 1002 that functions the same as a boot sector on any other partition of the hard drive. The terms “OS1” and “OS2” are intended to further distinguish the operating system that resides within the boot image from the operating system residing on the hard drive outside of the region used by the boot image.

In one embodiment OS1 and OS2 are different instances of the same operating system. Alternatively, OS1 and OS2 may be different operating systems. For example, the boot image operating system could be one of a Unix®, Linux, MS-DOS®, or other non-Microsoft® Windows® operating system while OS1 is a Microsoft® Windows® brand operating system. OS2 need not support the full functionality that OS1 supports. Even if OS1 and OS2 are different instances of the same operating system, OS2 may have considerably reduced functionality and size compared to OS1.

Referring again to FIG. 8, Microsoft® Windows® operating systems provide mechanisms to initiate application programs upon start up or to perform selected applications before shutting down. In one embodiment, the diagnostic process is designed to make the results of the diagnostics available for analysis by third parties. In step 840, the first operating system is instructed to re-launch the web browser with a URL indicative of the diagnostic web page. The results of the diagnostics or the identity and location of a file containing the results may also be provided with the URL. Referring to FIG. 3, web page button 214 (“analyze results”) would then be selectable.

In step 850, a reset is performed. This reset may be a “hard reset” or a “soft reset”, however, a “hard reset” (preferably by removal and re-application of power) is preferred for the diagnostics.

Upon reset, the computer begins the boot process illustrated in FIG. 5. Instead of the typical first operating system boot, however, the diagnostic boot loader (e.g., “bld.com”) is selected by default or user intervention in step 540.

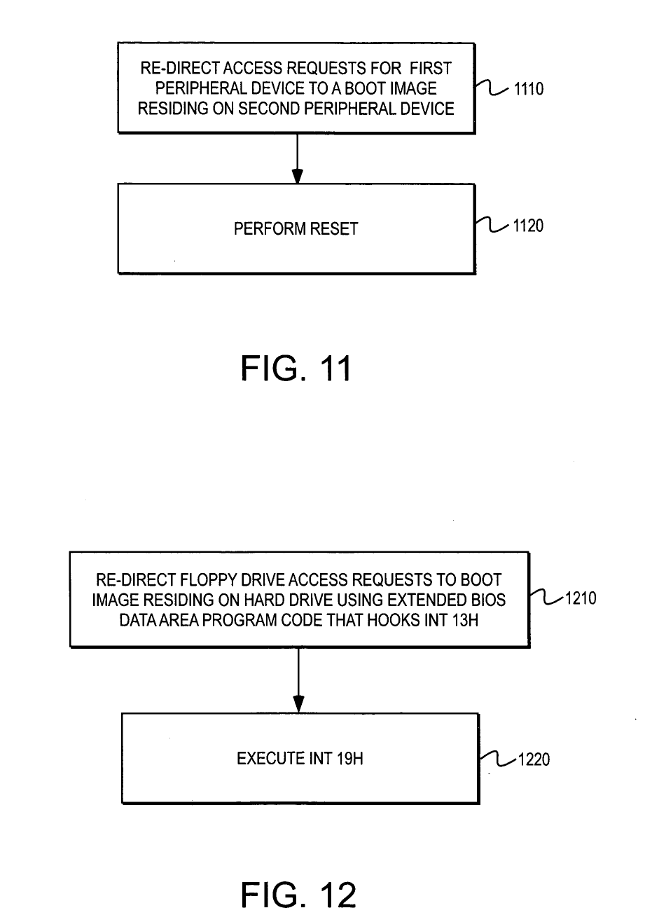

Referring to FIG. 11, the diagnostic boot loader re-directs access requests targeting a first peripheral device (e.g., a floppy drive) to a boot image residing on a second peripheral device (e.g., the hard drive) in step 1110. The boot image is thus referred to as a virtual floppy drive or virtual hard drive depending upon whether the boot loader re-directed hard drive access requests or floppy drive access requests to the boot image. In various embodiment, the virtual floppy boot image corresponds to a floppy disk of one of the following capacities: 160 KB, 180 KB, 250 KB, 320 KB, 360 KB, 500 KB, 720 KB, 1.2 MB, 1.44 MB, or 2.88 MB, where “KB” represents kilobytes and MB represents megabytes.

The diagnostic boot loader then issues an instruction to perform a reset in step 1120. The reset of 1120 is a “soft” reset so that the re-direction instructions are intact upon reset.

FIG. 12 illustrates the application of typical BIOS functions to implement the method of FIG. 11. In step 1210, access requests to the first peripheral device (e.g., floppy drive) are re-directed to the boot image residing on a second peripheral device (e.g., hard drive) by hooking the BIOS function interrupt 13h (INT 13h). Executable program code that hooks interrupt 13h to handle the re-direction is stored in the extended BIOS data area (XBDA). The XBDA is a region of the RAM 460.

A specific sector L of the boot image, for example, begins at the location D+f(L) within the active partition of the hard drive. D is the logical block address from the beginning of the active partition to the beginning of the boot image residing on the hard drive. f(L) is a mapping function designed to accommodate for the differences in sector sizes between the first drive that the boot image represents and the second drive that the boot image is actually stored on. The XBDA program code “hooks” the BIOS interrupt 13h function and performs the appropriate mapping to re-direct the access requests. The program code includes processor executable instructions for re-mapping access requests from the first peripheral device to the boot image residing on the second peripheral device. In step 1220, an interrupt 19h (INT 19h) is executed to perform a soft reset.

Although a boot sequence may include a floppy drive, optical drive, and hard drive, the sequence typically starts with the floppy drive. Upon the reset performed by the diagnostic boot loader, the boot sequence is effectively modified to ensure that floppy drive access requests are directed to the boot image. This boot image is sufficient to load an operating system, perform the diagnostics, and exit. An attempt to retrieve the boot sector from the first drive (e.g., floppy drive) is re-directed to provide the boot sector within the boot image residing on the hard drive. The boot process continues to load the operating system of the boot image and launch the diagnostics.

Once the diagnostics have been performed, the computer should be restored to the pre-diagnostics condition. To prevent subsequent resets of the computer from booting the diagnostic boot image, a hard reset should be performed at the conclusion of the diagnostics. The hard reset, for example, may clear or flush RAM 460 to ensure that the program code stored within the XBDA is eliminated. The hard reset eliminates the re-direction (and effective re-sequencing) of the boot sequence that was caused by the diagnostic boot loader code. However, unless the default operating system selection is altered, the diagnostic boot image will again be selected. Accordingly, the “boot.ini” file is modified to either eliminate the reference to the diagnostic boot loader or to select a reference to another operating system loader as the default.

In one embodiment, the diagnostics are configured to take the appropriate action to ensure that the normal boot process will be restored once the diagnostics have been performed. Referring to FIG. 1, for example, step 140 may include the steps of modifying the “boot.ini” file to eliminate the reference to the “bld.com” file. The “bld.com” and boot image files may optionally also be designated by the diagnostics for deletion.

Instead of providing an entry in the boot.ini file, the boot sector of the active partition could be modified to select the diagnostic boot loader. Modification of the boot sector is risky, however. In the event that the boot sector becomes corrupted the partition may become inaccessible. Alternatively, a series of file renaming could be performed to ensure that the diagnostic boot loader is executed rather than the first operating system boot loader. However, this approach will not work unless the name of the default boot loader of the first operating system is well defined (i.e., could be problematic for custom operating systems or a multiple operating system environment).

The boot image and associated techniques disclosed permit effectively changing the peripheral boot sequence (at least temporarily) without modifying any parameter data stored in the nonvolatile memory and without performing firmware BIOS modifications. Modification of boot sectors is not required. To minimize the impact to the hard drive of the computer being diagnosed, the “bld.com” and associated boot image may be deleted after the diagnostics have been performed.

Providing a common architecture allowing the same diagnostic tools to boot from a CD or from the web is important to minimize qualification cost and maximize re-use. Users with web access are able to perform diagnostics with the most up-to-date tools and drivers. Users without web access are able to perform diagnostics from the CD. The use of the common architecture permits the computer system manufacturer to provide a single boot image that may be updated over time rather than a plurality of boot images.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. A method of operating a computer, comprising:
a) re-directing access requests for a first peripheral device to a boot image residing on a second peripheral device of the computer; and
b) performing a reset, wherein the computer boots an operating system from the boot image.

2. The method of claim 1 wherein the access requests are re-directed while a first operating system is booted, wherein the operating system within the boot image is a second operating system.

3. The method of claim 2 wherein the first and second operating systems are distinct operating systems.

4. The method of claim 2 wherein step a) further comprises:
i) booting the computer with the first operating system;
ii) providing program code to hook a basic input output system (BIOS) function, wherein the program code re-directs access from the first peripheral device to the boot image residing on the second peripheral device; and
iii) performing a soft reset to reset the computer while leaving the program code intact.

5. The method of claim 4 wherein step (a)(ii) further comprises hooking the interrupt 13h BIOS function to re-direct access from the first peripheral device to the boot image residing on the second peripheral device.

6. The method of claim 2 further comprising:
c) executing a diagnostic program to generate a diagnostics result file.

7. The method of claim 6 further comprising:
d) rebooting the computer with the first operating system; and
e) providing the diagnostics result file to a website.

8. The method of claim 6 wherein the diagnostic program deletes the boot image.

9. The method of claim 1 further comprising:
c) downloading the boot image from a website to the second peripheral device.

10. The method of claim 1 wherein the first peripheral device is a floppy disk drive, wherein the second peripheral device is a hard disk drive.

11. The method of claim 1 further comprising:
c) downloading the boot image and associated driver files to the computer.

12. The method of claim 11 further comprising:
d) identifying a computer configuration; and
e) selecting the associated driver files to be downloaded in accordance with the computer configuration.

13. The method of claim 12 wherein step d) further comprises:
i) downloading a configuration program; and
ii) executing the configuration program to identify the computer configuration.

14. A method of diagnosing a computer, comprising:
a) downloading diagnostic software including a boot image and a diagnostic boot loader from a website while booted with a first operating system;
b) performing a reset, wherein the diagnostic boot loader is executed upon the reset to re-direct access of a first peripheral device to the boot image residing on a second peripheral device; and
c) performing a reset, wherein a second operating system residing within the boot image is loaded in response to requests to boot from the first peripheral device.

15. The method of claim 14 further comprising:
d) performing diagnostics while booted with the second operating system.

16. The method of claim 15 wherein the first and second operating systems are distinct operating systems.

17. The method of claim 14 further comprising:
d) executing a diagnostic program to generate a diagnostics result file.

18. The method of claim 17 wherein the diagnostic program deletes at least one of the boot image and the diagnostic boot loader.

19. The method of claim 17 further comprising:
e) performing a reset to boot the computer with the first operating system; and
f) providing the diagnostics result file to a website.

20. The method of claim 14 wherein the first peripheral device is a floppy disk drive, wherein the second peripheral device is a hard disk drive.

21. A method of operating a computer, comprising:
a) means for re-directing access requests for a first peripheral device to a boot image residing on a second peripheral device of the computer; and
b) means for resetting the computer while preserving re-direction of the access requests, wherein the computer boots an operating system from the boot image.

22. An apparatus comprising:
a computer usable medium storing processor-executable instructions, wherein when executed the instructions cause the computer to re-direct access requests for a first peripheral device to a boot image residing on a second peripheral device of the computer, wherein the instructions further cause the computer to perform a reset and boot an operating system from the boot image.
